(19) United States
(12) Patent Application Publication
(10) Pub. No.: US 2012/0030053 A1
(43) Pub. Date: Feb. 2, 2012

(54) Method and system for live online bidding and broadcasting of live online bidding utilizing a variety of electronic devices and systems

(76) Inventor: Albert Feinstein, New York, NY (US)

(21) Appl. No.: 12/848,550

(22) Filed: Aug. 2, 2010

(51) Int. Cl. G06Q 30/00

(52) U.S. Cl. 705/26.3

(57) ABSTRACT

The present system and method allow for completely live online bidding utilizing a variety of electronic devices and systems. The present invention allows users to see and hear a live bidding event while bidding live on merchandise. The bidding happens live and in real time using a system that simultaneously and continuously receives, processes, prepares and broadcasts data in a live manner.

### ABSTRACT

The present system and method allow for completely live online bidding utilizing a variety of electronic devices and systems. The present invention allows users to see and hear a live bidding event while bidding live on merchandise. The bidding happens live and in real time using a system that simultaneously and continuously receives, processes, prepares and broadcasts data in a live manner.

### CLAIMS

### Therefore the Invention Claimed is:

1. A method for simultaneously and continuously receiving, processing, preparing and broadcasting data for live online bidding, the method comprising: activation of live online bidding system; live broadcasting of live audio/video streaming of the live online bidding event by the live online bidding system; live broadcasting of live online data streaming by live online bidding system; live broadcasting of live mobile streaming by live online bidding system; live broadcasting of live television streaming by live online bidding system; live submitting of bids by enrolled bidders from a variety of electronic devices; live receiving of bid data by live online bidding system; live processing of bid data by the live online bidding system; live presenting and structuring of processed bid data by live online bidding system; live broadcasting of processed and structured bid data by live online bidding system to a variety of electronic devices; terminating of the live online bidding system.

2. The method of claim 1 wherein the bidding system activates at a predetermined time or at the discretion of the system administrator.

3. The method of claim 1 wherein, upon activation of the live online bidding system, various sub-systems and system devices are also activated 4. The method of claim 1 wherein enrolled bidders can place live bids using a variety of electronic devices including, but not limited to computers, mobile devices and televisions.

5. The method of claim 4 wherein bids placed by enrolled bidders are transmitted live over a variety of communications networks to the live online bidding system for receiving and processing.

6. The method of claim 1 wherein the live online bidding system processes the received bid data by comparing all of the received bid data based on predetermined rules and determines the bid to be structured for presentation.

7. The method of claim 6 wherein the processed bid data is prepared and structured for presentation and broadcasting over a variety of communications networks.

8. The method of claim 1 wherein the structured bid data is broadcasted live and in real time by the live online bidding system over a variety of communications networks to be seen by end users on a variety of electronic devices including, but not limited to computers, mobile devices and televisions.

9. The method of claim 1 wherein the live online bidding system continuously broadcasts live updated bidding information and history, over a variety of communications networks to be seen by end users on a variety of electronic devices including, but not limited to computers, mobile devices and televisions.

10. The method of claim 1 wherein time can be added to the bidding clock when necessary, as determined by the system administrator.

11. The method of claim 1 wherein the live online bidding system terminates automatically at a predetermined time or at the discretion of the system administrator.

12. A live online bidding system, the system comprising: means for receiving data from a variety of networks; means for processing data received from a variety of networks; means for structuring and presenting processed data; means for broadcasting data to a variety of networks.

13. The system of claim 12 wherein live online data streaming broadcasting begins automatically upon activation of the live online bidding system.

14. The system of claim 13 wherein live online data streaming is continuously transmitted by the live online bidding system over a communications network to be seen by end users on a variety of electronic devices including, but not limited to computers, mobile devices and televisions.

15. The system of claim 12 wherein live audio/video streaming broadcasting begins automatically upon activation of the live online bidding system.

16. The system of claim 15 wherein live audio/video streaming of the live online bidding event is continuously broadcasted by the live online bidding system over a communications network to be seen by end users on a variety of electronic devices including, but not limited to computers, mobile devices and televisions.

17. The system of claim 12 wherein live mobile streaming broadcasting begins automatically upon activation of the live online bidding system.

18. The system of claim 17 wherein live mobile streaming of live bidding information is continuously broadcasted by the live online bidding system over a mobile communications network to preregistered mobile devices to be seen by end.

19. The system of claim 12 wherein live television streaming begins automatically upon activation of the live online bidding system.

20. The system of claim 19 wherein live television streaming is continuously transmitted by the live online bidding system over a communications network to be seen by end users on television systems.

### BACKGROUND OF THE INVENTION

1. Field of the Invention

The present invention is generally related to the field of online commerce. More specifically, the present invention relates to the method and system for live interactive bidding and live transmittal of such bidding and bidding event.

2. Description of the Background

It is well known today that people can readily and easily buy and sell goods and services over the internet. Commerce over the internet has become very commonplace in society, allowing people to purchase almost anything with the click of a button. It is known that merchandise is listed for sale on the internet and that websites exist where a plurality of users can place monetary bids on real estate properties.

The prior art, however, exhibits significant limitations. Prior art does not allow users to see, hear and bid on the item of their choosing in a live format. Although prior art allows for online bidding of merchandise, prior art does not have a system and method that allow for live bidding in real time. The prior art does not allow participants to bid live while watching and hearing a live bidding event. Instead, prior art has a countdown until the bidding process is over and when that countdown is complete, the bidding terminates. This is not truly live and thus it has limitations. For the prior art bidding process, bidders can sneak bids in at the last second and win just as the countdown reaches zero. This is a disadvantage for other bidders and also for the seller of the merchandise, as perhaps the seller could have gotten more bids. Therefore, there is need for a truly live bidding process and system.

In addition, prior art limits devices that could be utilized for live bidding. For example, the prior art does not have capabilities to provide live bidding from mobile systems or television. The prior art limitations significantly restrict participants's choices and options to participate.

### BRIEF SUMMARY OF THE INVENTION

The present invention provides for a method and system for live online bidding. As described in the description of the background, prior art does not allow for true live bidding on merchandise. The present invention allows users to bid on merchandise live from a variety of electronic devices. The present method and system allows for users to see and hear the bidding event live and in real time. This is something that cannot be found in prior art. The system is able to broadcast streaming audio/video and data to a variety of electronic devices. This truly live bidding allows users to have a much better buying and selling experience. It is easier and more efficient for bidders, which consequently makes the process better for both bidders and sellers. As stated earlier, the fact that bidders can continue to bid until the item is sold and not until the clock runs out is a great advantage for both bidders and sellers.

The present invention also allows users to bid from a variety of different devices. Bidding from certain devices, such as mobile devices, using certain systems, such as mobile systems, cannot be found in prior art. The fact that the present invention allows users to bid live from more devices than is possible in the prior art allows for more options. More options means the present system and method make the process easier and move convenient, as well as more efficient.

### BRIEF DESCRIPTION OF THE DRAWINGS

The present invention can be better understood by referencing the following drawings. The following drawings provide a thorough view of how the process described herein works.

FIG. 1 is a diagram that depicts the live online bidding system and method. The diagram shows the process of live bidding using the system, the capabilities of the system and how the system interacts with a variety of other systems and networks.

### DETAILED DESCRIPTION OF THE INVENTION

The present invention will now be described in detail as it is illustrated in the drawings. As stated earlier, the present invention generally relates to the field of internet commerce and, more specifically, relates to the method and system for simultaneously receiving, processing, preparing and broadcasting data for live online bidding. The present invention allows for true live online bidding in real time using a variety of electronic devices.

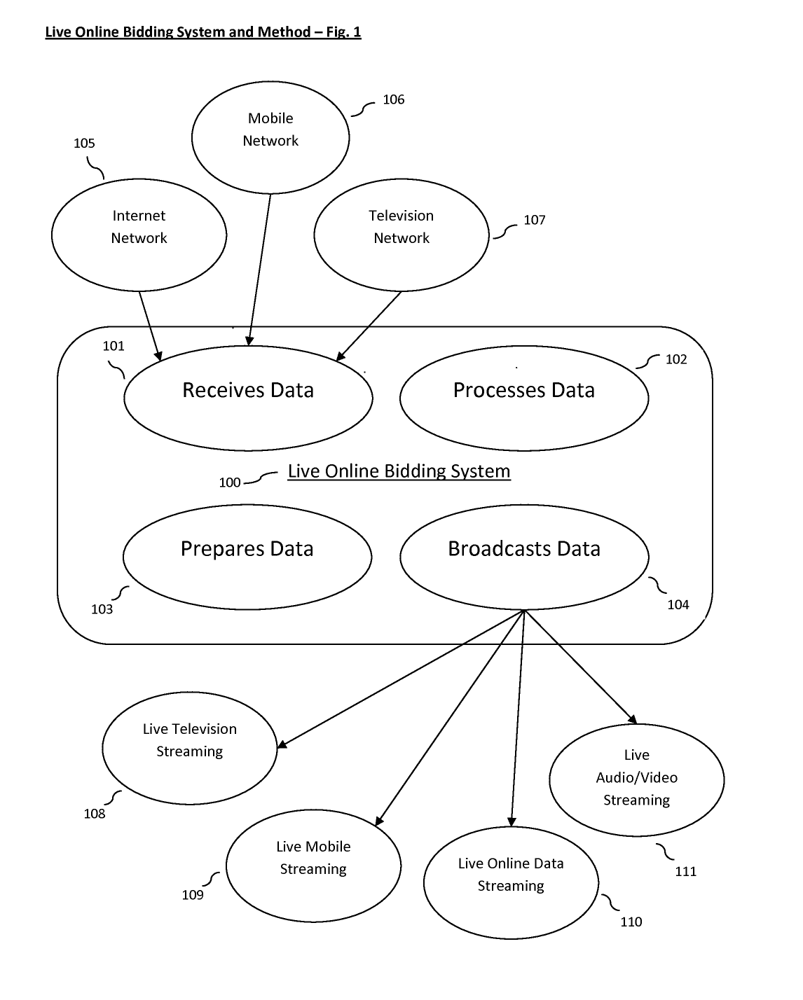

FIG. 1 is a diagram of the entire live online bidding system and method. Block 100 is the live online bidding system as described in the present invention. This live online bidding system is composed of sub-systems that receive data, process data, prepare data and broadcast data, as seen in blocks 101-104. All of the systems, sub-systems and system devices detailed in the present invention work simultaneously and continuously together upon activation. The live online bidding system activates at either a predetermined time or at the discretion of the system administrator. The system administrator monitors and moderates the system itself. The system administrator also has the ability to activate and terminate all or any of the systems, sub-systems and system devices at the system administrator's discretion.

Unless the system administrator chooses otherwise, upon activation of the live online bidding system, various sub-systems and devices are also activated. As stated above, the sub-systems activated are the data receiving system, the data processing system, the data preparation system and the data broadcasting system. Additionally, devices such as the bidding clock are also activated. The bidding clock is a system device that is used to temporally measure the duration of the live online bidding event. However, this bidding clock can be adjusted as necessary by the system administrator or the duration of the live online bidding event can be determined by the system administrator regardless of the bidding clock.

As stated above, the activation of the live online bidding system also activates the sub-systems. Block 101 in the diagram describes the data receiving sub system that receives data from a variety of communications networks. When an enrolled bidder places a bid using a remote electronic device, that data travels over a communications network to the live online bidding system. The live online bidding system has the capability to receive data from a variety of networks, including but not limited to internet networks, mobile networks and television networks, as described in blocks 105-107. Depending on which electronic device the bidder uses to place the bid and how the enrolled bidder places the bid from that device, the bid data will travel over a certain communication network to be received by the live online bidding system. Once the data has been received by the live online bidding system, the data must be processed by the system. Data is processed by the data processing sub-system as described in the diagram in block 102. The live online bidding system processes incoming bid data by comparing the bids against one another. Based on predetermined rules within the system, the live online bidding system determines the order and amount of each bid. Once the bidding data from various bidding devices has been processed, the live online bidding system prepares and categorizes the data for delivery and display to end users. This preparation is done by structuring sub-system as described in step 103 in the diagram. Once the data is prepared and properly structured the data is transferred to the broadcasting sub-systems to be delivered to end users.

The live online bidding system can broadcast data in a variety of ways over a variety of communication networks. Broadcasting of data is done by the broadcasting sub-system as seen in block 104 of the diagram. Upon activation of the system, live audio/video streaming of the bidding event is broadcasted to a variety of electronic devices by the live online bidding system. The purpose of this is so that end users can watch and hear the live online bidding event on their chosen electronic device. People can watch and hear this live audio/video feed using a variety of electronic devices, including but not limited to computers, mobile devices and televisions. The live online bidding system has the capability to broadcast and transmit live audio/video streaming, as depicted in block 111, so that the end user can actually watch and hear the bidding event in real time. This is not currently done in prior art. The live online bidding system can also broadcast live online data streaming to end users. The live online bidding system broadcasts live online data streaming, as seen in block 110, which includes such data as bidding information, bidding history, participants, current and past bids, available increments and decrements. The bidding clock is also broadcast via live online data streaming. Next, the live online bidding system has the capability to broadcast data via live mobile streaming as seen in block 109. Upon activation of the live online bidding system, bidding data and information is sent via live mobile streaming to preregistered mobile devices. Updated data is continuously broadcasted in this manner as necessary. Finally, the live online bidding system has the capability to broadcast data via live television streaming as seen in block 108. Upon activation of the live online bidding system, bidding data and information is sent via live mobile streaming to preregistered mobile devices. Updated data is continuously broadcasted in this manner as necessary.

Many variations of the present invention are possible once this present invention is known to people skilled in the field of invention. Additionally, these variations are within the spirit and the scope of the present invention as it is described in the claims, the description and throughout this document.

Therefore the invention claimed is:

1. A method for simultaneously and continuously receiving, processing, preparing and broadcasting data for live online bidding, the method comprising: activation of live online bidding system; live broadcasting of live audio/video streaming of the live online bidding event by the live online bidding system; live broadcasting of live online data streaming by live online bidding system; live broadcasting of live mobile streaming by live online bidding system; live broadcasting of live television streaming by live online bidding system; live submitting of bids by enrolled bidders from a variety of electronic devices; live receiving of bid data by live online bidding system; live processing of bid data by the live online bidding system; live presenting and structuring of processed bid data by live online bidding system; live broadcasting of processed and structured bid data by live online bidding system to a variety of electronic devices; terminating of the live online bidding system.

2. The method of claim 1 wherein the bidding system activates at a predetermined time or at the discretion of the system administrator.

3. The method of claim 1 wherein, upon activation of the live online bidding system, various sub-systems and system devices are also activated

4. The method of claim 1 wherein enrolled bidders can place live bids using a variety of electronic devices including, but not limited to computers, mobile devices and televisions.

5. The method of claim 4 wherein bids placed by enrolled bidders are transmitted live over a variety of communications networks to the live online bidding system for receiving and processing.

6. The method of claim 1 wherein the live online bidding system processes the received bid data by comparing all of the received bid data based on predetermined rules and determines the bid to be structured for presentation.

7. The method of claim 6 wherein the processed bid data is prepared and structured for presentation and broadcasting over a variety of communications networks.

8. The method of claim 1 wherein the structured bid data is broadcasted live and in real time by the live online bidding system over a variety of communications networks to be seen by end users on a variety of electronic devices including, but not limited to computers, mobile devices and televisions.

9. The method of claim 1 wherein the live online bidding system continuously broadcasts live updated bidding information and history, over a variety of communications networks to be seen by end users on a variety of electronic devices including, but not limited to computers, mobile devices and televisions.

10. The method of claim 1 wherein time can be added to the bidding clock when necessary, as determined by the system administrator.

11. The method of claim 1 wherein the live online bidding system terminates automatically at a predetermined time or at the discretion of the system administrator.

12. A live online bidding system, the system comprising: means for receiving data from a variety of networks; means for processing data received from a variety of networks; means for structuring and presenting processed data; means for broadcasting data to a variety of networks.

13. The system of claim 12 wherein live online data streaming broadcasting begins automatically upon activation of the live online bidding system.

14. The system of claim 13 wherein live online data streaming is continuously transmitted by the live online bidding system over a communications network to be seen by end users on a variety of electronic devices including, but not limited to computers, mobile devices and televisions.

15. The system of claim 12 wherein live audio/video streaming broadcasting begins automatically upon activation of the live online bidding system.

16. The system of claim 15 wherein live audio/video streaming of the live online bidding event is continuously broadcasted by the live online bidding system over a communications network to be seen by end users on a variety of electronic devices including, but not limited to computers, mobile devices and televisions.

17. The system of claim 12 wherein live mobile streaming broadcasting begins automatically upon activation of the live online bidding system.

18. The system of claim 17 wherein live mobile streaming of live bidding information is continuously broadcasted by the live online bidding system over a mobile communications network to preregistered mobile devices to be seen by end.

19. The system of claim 12 wherein live television streaming begins automatically upon activation of the live online bidding system.

20. The system of claim 19 wherein live television streaming is continuously transmitted by the live online bidding system over a communications network to be seen by end users on television systems.
